(19) United States
(12) Patent Application Publication
(10) Pub. No.: US 2007/0099574 A1
(43) Pub. Date: May 3, 2007

(54) Electronic Device Capable of Operating According to Detection of Environmental Light

(76) Inventor: Chen-Kang Wang, Taipei City (TW)

Correspondence Address: NORTH AMERICA INTELLECTUAL PROPERTY CORPORATION, P.O. BOX 506, MERRIFIELD, VA, 22116, US

(21) Appl. No.: 11/555,671

(22) Filed: Nov. 1, 2006

(30) Foreign Application Priority Data
Nov. 3, 2005 (TW) 094138578

(51) Int. Cl. H04B 7/00; H04B 17/00; H04B 1/38

(52) U.S. Cl. 455/67.11; 455/41.2; 455/574

(57) ABSTRACT

An electronic device includes a reflective proximity sensor for emitting light and detecting whether a wavelength of a reflective light is the same as a wavelength of the light emitted by the reflective proximity sensor, an optical sensor for sensing variation of environmental light, and a controller coupled to the reflective proximity sensor and the optical sensor for controlling operations of the electronic device according to a detection result of the reflective proximity sensor and a detection result of the optical sensor. Hence the electronic device can determine whether it is being placed into a handbag or a pocket.

### BACKGROUND OF THE INVENTION

1. Field of the Invention

The present invention relates to an electronic device capable of operating a function according to detection of light, and more particularly, to an electronic device capable of controlling a function whether a wavelength of a reflective light received by detecting a reflective proximity sensor is identical to a wavelength of light emitted by the reflective proximity sensor and according to a detection result of variation of the environmental light.

2. Description of the Prior Art

In highly developed information communication systems in the modern information society, electronic devices are widely utilized in every area. For instance, the utilization of a convenient and lightweight mobile phone device has become a common means of communication in our daily life; users can easily exchange and share information, experiences, and opinions through the convenience of the mobile phone device. The development and usage of mobile phones has increased tremendously. This has directly resulted in an increase in production of mobile phones and of course, a correspondingly large increase in the development, design, and production, of mobile phone related products. The trend in mobile phone design continues as it has been since the mobile phones inception. The mobile phone is increasingly becoming smaller in size; therefore, enabling a user to enjoy their mobile phone (e.g., or any other portable electronic device) with more ease. However, an important issue of portable electronic device design is to provide power saving scheme for a highly functional mobile phone so that the stand-by time can be extended.

However the current wireless handheld electronic device such as a mobile phone and a personal digital assistant (PDA) mobile phone, sometimes have keypads where one or more keys on the keypad may be accidentally pressed. For example, the keypad of the electronic device may be triggered unintentionally and inappropriately when it is placed inside a pocket of a pair of trousers or inside a shoulder handbag. When the mobile phone is activated (i.e., changed state from a sleep or stand-by state to an active or ready-to-use state), it is very possible that a call is made. A second example of unwanted and rouge mobile phone operation is data being sent (i.e., transmitted). This causes unnecessary power consumption as the phone is being switched from a stand-by mode to a calling mode. Additionally, a severe security risk exists whereby confidential data may be transmitted unintentionally.

A current keylock mechanism is utilized by the electronic device to prevent this very problem and it works something like this. By pressing a combination of buttons, the user is able to manually lock the keypad. Later, when it is desired that the mobile phone be required to perform a call or perform some other functions, the user then presses the identical combination of buttons to unlock the keypad. Please refer to UK patent GB2314739: Disabling Key Scanning Operation in a Mobile Phone, by Samsung Electronics for additional information. However, the way of proceeding to resolve the unintentional state changes of the mobile phone (e.g., from stand-by to calling mode) does offer inconvenience to the user. The unlocking process requires the user to press a plurality of keypad keys located on the mobile phone's keypad and to do so in the exact same combination as locking the keypad. Entering the combination of buttons (i.e., keys) can be very inconvenient to the mobile phone user. Subsequently, an automatic keylock function was developed; where a user can define a set timer. Should the user wish to place the mobile phone in a locked state then the user initiates a timer sequence. The keypad will then automatically be locked when the time sequence reaches an expiration value. In other words, after a predetermined time passes, the mobile phone automatically enters a time-out (i.e., after a set/predetermined) idle time, the keypad is automatically locked. For additional information please refer to Korean patent KR2000044370: Method for Automatically Locking Keypads in Cellular Phone, by Samsung Electronics, and German patent DE10235546: Automatic Keypad Unlocking Device for Mobile Telephones Operated on the Basis of Several Key Inputs Set to Lock or Unlock the Keypad, by Agere System. But if the automatic keylock function is being utilized, under any circumstances, even when the mobile phone is not placed inside the pants pocket or in the handbag and is not required to be locked, the keypad will still be automatically locked after a set time. This causes an inconvenience to the user as they will be required to enter the keypad unlocking sequence by entering the same combination of buttons that were utilized when the locking mode was defined (i.e., established). In conclusion, the current automatic keylock mechanism does not satisfy the user's needs, and there is no unlocking mechanism present.

### SUMMARY OF THE INVENTION

An embodiment of the claimed invention discloses an electronic device capable of operating a function according to detection of environmental light. The electronic device comprises a reflective proximity sensor for emitting light and detecting whether a wavelength of a reflective light received by the reflective proximity sensor is identical to the wavelength of the light emitted by the reflective proximity sensor, an optical sensor for sensing variation of the environmental light, and a controller coupled to the reflective proximity sensor and the optical sensor for controlling the operation of the electronic device according to the detection result of the reflective proximity sensor and the detection result of the optical sensor.

Another embodiment of the claimed invention discloses a method of controlling an electronic device to execute a corresponding function according to the detection of environmental light. The method comprises emitting light, detecting whether a wavelength of a reflective light received is identical to a wavelength of the light emitted, detecting variation of the environmental light, and controlling the electronic device to execute the corresponding function according to a detection result of the wavelengths of the reflective light and the light emitted and the variation of the environmental light.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates an external view of an electronic device of the present invention.

FIG. 2 illustrates a functional block diagram of an electronic device of the present invention.

FIG. 3 illustrates a flowchart of an electronic device executing corresponding functions according to a result of light detection.

FIG. 4 illustrates a diagram of an electronic device being disposed within and remaining inside a handbag.

### DETAILED DESCRIPTION

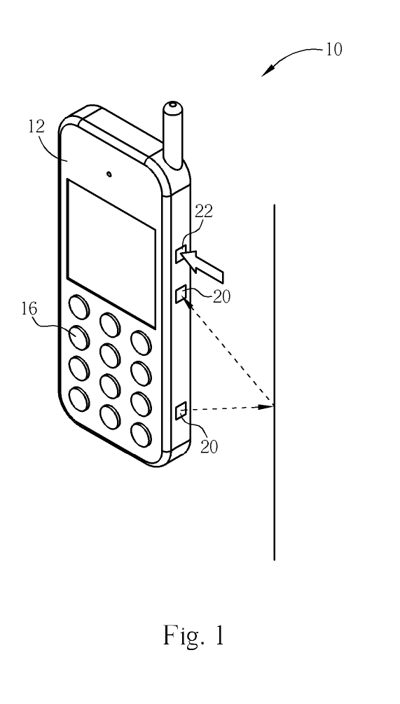

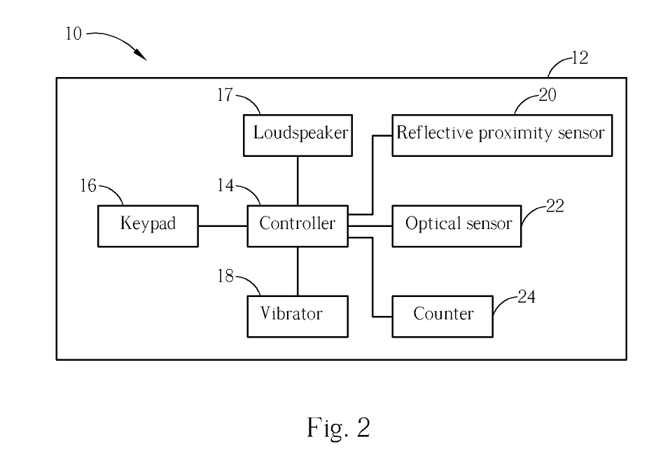

Please refer to FIG. 1 and FIG. 2. FIG. 1 illustrates an external view of an electronic device 10 of the present invention. FIG. 2 illustrates a functional block diagram of an electronic device 10 of the present invention. The electronic device 10 can be a mobile phone or a personal digital assistant (PDA). In fact, the spirit of the present invention is not limited by the example offered here. The electronic device 10 includes a housing 12 for containing internal components, a controller 14 for controlling operations of the electronic device 10, a keypad 16 coupled to the controller 14 for inputting control command by a user, a loudspeaker 17 coupled to the controller 14 for converting the signal transmitted from the controller into sound waves and for outputting sound transmitted from a far end or a ring tone of the mobile phone in a wireless manner, and a vibrator 18 coupled to the controller 14 for prompting the user that there is an incoming call or short text message when the mobile phone is in a vibration mode.

Furthermore, the electronic device 10 further includes a reflective proximity sensor 20, at least an optical sensor 22, and a counter 24. The reflective proximity sensor 20 is installed on the housing 12 and coupled to the controller 14 for emitting light and detecting whether a wavelength of a reflective light received by the reflective proximity sensor is identical to a wavelength of the light emitted by the reflective proximity sensor, wherein the reflective proximity sensor 20 is a micro reflective proximity sensor, and the light can be infrared; the optical sensor is installed on the housing 12 and coupled to the controller 14 for sensing variation of environmental light, the optical sensor can be a CDS optical sensor; the counter is installed in the housing 12 and is coupled to the controller 14 for counting a waiting time and generating a count result.

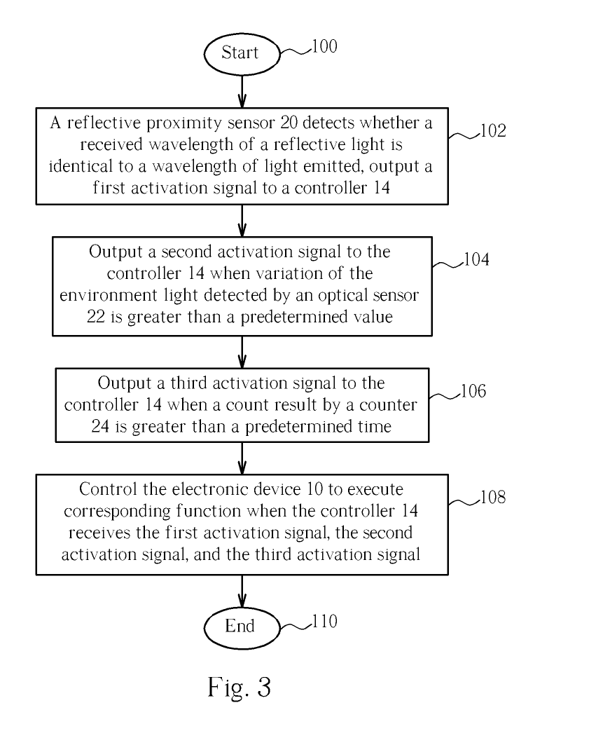

Please refer to FIG. 3. FIG. 3 illustrates a flowchart of an electronic device 10 executing corresponding functions according to a result of light detection. The method of the present invention includes the following steps:

Step 100: start;

Step 102: a reflective proximity sensor 20 detects whether a received wavelength of a reflective light is identical to a wavelength of the light emitted, output a first activation signal to a controller 14;

Step 104: output a second activation signal to the controller 14 when variation of the environmental light detected by an optical sensor 22 is greater than a predetermined value;

Step 106: output a third activation signal to the controller 14 when a count result by a counter 24 is greater than a predetermined time;

Step 108: control the electronic device 10 to execute corresponding function when the controller 14 receives the first activation signal, the second activation signal, and the third activation signal; and

Step 110: end.

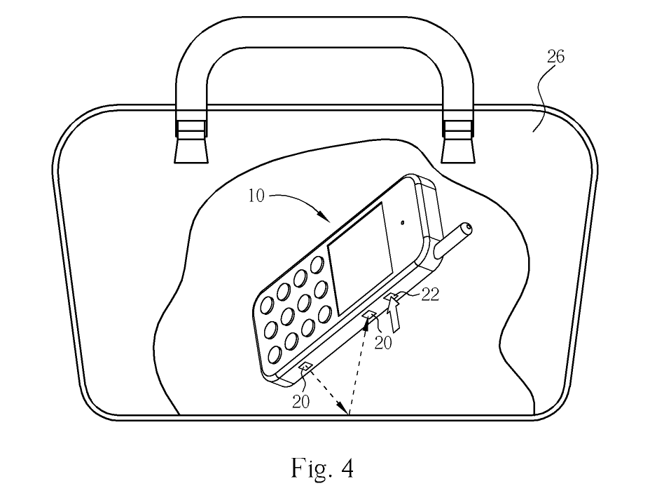

For example, please refer FIG. 4. FIG. 4 illustrates a diagram of an electronic device 10 being disposed within and remaining inside a handbag 26. When the electronic device 10 is disposed within and remained inside a handbag or a pants pocket (i.e., the pockets of a pair of trousers), light emitted from the reflective proximity sensor 20 will be reflected by surrounding objects also disposed within the handbag 26, and the reflective proximity sensor 20 will output a first activation signal to the controller 14 that the wavelength of the reflective light detected is identical to the wavelength of the light emitted; as the electronic device 10 is being disposed within in the handbag 26 (i.e., remains in the shoulder handbag), the environmental light of the electronic device 10 changes from bright to dim instantly, as the optical sensor 22 can detect the variation of the environment ambient light increases instantly, if the variation is greater than the predetermined value, then a second activation signal is outputted to the controller 14. The predetermined value can be set according to any requirement, which means that if the sensing result of the optical sensor 22 is required to be more sensitive (a small change in light variation is read as the electronic device 10 is being put into the shoulder handbag 26), and the predetermined value can be set to be smaller; if the sensing result of the optical sensor 22 is not required to be sensitive (only a great change in light variation is interpreted as the electronic device 10 is being put into the shoulder handbag 26), and the predetermined value can be set to be greater; furthermore, a waiting time is established at the time the two conditions of the above-mentioned are calculated, then the counter 24 can be utilized for outputting a third activation signal to the controller when the count result is greater than a predetermined time. The controller 14 will only control the electronic device 10 to execute the corresponding functions after the controller 14 receives the first activation signal, the second activation signal, and the third activation signal. In other words, the electronic device 10 will only execute the corresponding functions if the three conditions of the reflective light received by the reflective proximity sensor 20, the optical sensor 22 detecting the variation of the environmental light increases instantly, and the condition of exceeding the predetermined time are all satisfied. If any one of these three conditions is not satisfied, the electronic device 10 will not execute the corresponding functions. The three conditions of the above-mentioned have to be established to prevent erroneous conditions where the electronic device 10 executes the corresponding functions when in fact the need does not exist. The three conditions of the above-mentioned have further been established as needing to take place concurrently for the electronic device 10 to execute the corresponding functions. If only the condition of the reflective light received by the reflective proximity sensor 20 is considered, and not the variation of the environmental light, or if the electronic device 10 is only covered by other objects and not placed inside the shoulder handbag 26, there may be an error as the reflective proximity sensor 20 is unable to receive the reflected light; furthermore if only the condition of the variation of the environmental light is considered, and the reflective proximity sensor 20 is not considered, there may be an error as variation of the environmental light increases instantly as the user walks from a bright outdoor location into a dim indoor location. Therefore when the qualified duration of the conditions in step 102 and step 104 are greater than the predetermined time, the controller 14 will control the electronic device 10 to execute a corresponding function. In addition, step 102, step 104, and step 106 can be executed simultaneously.

In step 108, the controller 14 controls the electronic device 10 to execute corresponding function, which the electronic device is being controlled to execute a keylock function on the keypad 16, in this way the user would not accidentally press the keypad 16 and result in a call being made or data being sent out, which leads to unnecessary power consumption as the phone is switched from a stand-by mode to a calling mode; or which the electronic device 10 is being controlled to execute a volume increase function on the loudspeaker 17, this way even though the electronic device 10 is left in the shoulder handbag or the pants pocket, the user can hear the ring tone of incoming calls or text messages; or which the electronic device 10 is being controlled to execute a switch function of switching the vibration mode corresponding to the vibrator 18 to the ring mode corresponding to the loudspeaker, this way even though the electronic device 10 is originally in the vibration mode and is disposed in the handbag or the pants pocket, the user can hear the ring tone of the incoming calls or text messages after the switch function is executed.

The installation of the location and the number of the reflective proximity sensor 20 and the optical sensor 22 of the present invention can be set according to the requirement at hand, for example, if the determination of the reflective proximity sensor 20 must maintain a very high level of accuracy, then a plurality of reflective proximity sensors 20 can be installed at various locations of the electronic device 10 to reduce error caused by objects covering the electronic device 10 in a single direction; however, in doing so, cost will need to be considered.

When the electronic device 10 is removed from the handbag or the pants pocket, one or both conditions from step 102 and step 104 are removed, and the counter condition is also removed, it can be determined that the electronic device 10 is being removed from the handbag or the pants pocket, the controller 14 can be set to disengange all corresponding functions executed by the electronic device 10, for example, unlocking the keypad 16, the broadcast volume of the loudspeaker 17 is set to its original settings, or switching the ring mode back to the vibration mode.

If the present invention is applied to a mobile phone, a baseband processor that executes wireless communication functions can be used to replace the controller 14. For example, an ADIN signal end of the baseband processor can receive a voltage signal transmitted from the optical sensor 22, and the voltage signal is being processed by the baseband processor to obtain a corresponding light signal; and a pulse width modulation (PWM) signal end of the baseband processor can output a signal in a PWN manner to control the reflective proximity sensor 20 to emit infrared rays, and the result of the reflective light detected by the reflective proximity sensor 20 can be inputted through a GPIO signal end of the baseband processor to the baseband processor for processing. In this way, no additional processor is required to be installed within the mobile phone to execute the operation of the present invention, hence cost can be reduced.

In comparison to the prior art, the method and the electronic device of the present invention controls the operation of the electronic device according to whether the reflective light is being received and the detection result of the variation of the environment light, in this way even when the electronic device is covered by objects, the electronic device will not mistakenly determine that it has been placed inside a handbag or a pants pocket. Instant increase in variation of the environmental light as the user walks from a bright outdoor into a dim indoor would also not cause the electronic device to make false determination. Therefore the present invention can accurately determine whether the electronic device is being placed into the handbag or the pants pocket, as the present invention can provide a keylock or unlock mechanism to suit the user's requirement.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An electronic device capable of operating according to detection of environmental light, the electronic device comprising:
a reflective proximity sensor for emitting light and detecting whether a wavelength of a reflective light received by the reflective proximity sensor is identical to a wavelength of the light emitted by the reflective proximity sensor;
an optical sensor for sensing variation of the environmental light; and
a controller coupled to the reflective proximity sensor and the optical sensor for controlling operations of the electronic device according to a detection result of the reflective proximity sensor and a detection result of the optical sensor.

2. The electronic device of claim 1 further comprising a counter coupled to the controller, the controller being utilized for controlling the operations of the electronic device according to the detection result of the reflective proximity sensor, the detection result of the optical sensor, and a count result of the counter.

3. The electronic device of claim 2 wherein the reflective proximity sensor is utilized for outputting a first activation signal to the controller when the wavelength of the light received by the reflective proximity sensor is identical to the wavelength of the light emitted by the reflective proximity sensor, the optical sensor is utilized for outputting a second activation signal to the controller when variation of the environmental light detected is greater than a predetermined value, the counter is utilized for counting time greater than a predetermined time and outputting a third activation signal to the controller, and the controller is utilized for controlling the operations of the electronic device when the first activation signal, the second activation signal, and the third activation signal are received.

4. The electronic device of claim 1 wherein the reflective proximity sensor is utilized for outputting a first activation signal to the controller when the wavelength of the light received by the reflective proximity sensor is identical to the wavelength of the light emitted by the reflective proximity sensor, the optical sensor is utilized for outputting a second activation signal to the controller when the variation of the environmental light detected is greater than a predetermined value, and the controller is utilized for controlling the operations of the electronic device when the first activation signal and the second activation signal are received.

5. The electronic device of claim 1 further comprising a keypad wherein the controller is utilized for controlling the electronic device to execute a key lock function according to the detection result of the reflective proximity sensor and the detection result of the optical sensor.

6. The electronic device of claim 1 further comprising a loudspeaker wherein the controller is utilized for controlling the electronic device to execute a volume increase function according to the detection result of the reflective proximity sensor and the detection result of the optical sensor.

7. The electronic device of claim 1 further comprising a loudspeaker and a vibrator, wherein the controller is utilized for controlling the electronic device to switch from a vibration mode corresponding to the vibrator to a ring mode corresponding to the loudspeaker according to the detection result of the reflective proximity sensor and the detection result of the optical sensor.

8. The electronic device of claim 1 wherein the controller is a baseband processor.

9. The electronic device of claim 1 wherein the electronic device is a mobile phone.

10. The electronic device of claim 1 wherein the electronic device is a personal digital assistant (PDA).

11. A method of controlling an electronic device to execute corresponding function according to detection of environment light, the method comprising following steps:
(a) emitting light;
(b) detecting whether a wavelength of a reflective light received is identical to a wavelength of the light emitted in step (a);
(c) detecting variation of the environmental light; and
(d) controlling the electronic device to execute a corresponding function according to detection results of step (b) and step (c).

12. The method of claim 11 wherein step (a) and step (b) are executed simultaneously.

13. The method of claim 11 wherein step (a) and step (c) are executed simultaneously.

14. The method of claim 11 further comprising:
(e) calculating a waiting time and generating a count result, step (d) further comprising controlling the electronic device to execute a corresponding function according to the count result and the detection results of step (b) and step (c).

15. The method of claim 14 wherein step (b) comprises detecting whether the wavelength of the light received is identical to the wavelength of the light of step (a) and outputting a first activation signal, step (c) comprising outputting a second activation signal when variation of the environmental light detected is greater than a predetermined value, step (e) further comprising outputting a third activation signal when the counting result is greater than a predetermined time, and controlling the electronic device to execute corresponding function when the first activation signal, the second activation signal, and the third activation signal are received.

16. The method of claim 11 wherein step (b) comprises detecting the wavelength of the light received is identical to the wavelength of the light of step (a) and outputting a first activation signal, step (c) comprising outputting a second activation signal when variation of the environmental light detected is greater than a predetermined value, step (d) further comprising controlling the electronic device to execute corresponding function when the first activation signal and the second activation signal are received.

17. The method of claim 11 wherein step (d) comprises controlling the electronic device to execute a key lock function according to the detection results of step (b) and step (c).

18. The method of claim 11 wherein step (d) comprises controlling the electronic device to execute a volume increase function according to the detection results of step (b) and step (c).

19. The method of claim 11 wherein step (d) comprises controlling the electronic device to switch from a vibration mode to a ring mode according to the detection results of step (b) and step (c).
